(19) United States
(12) Patent Application Publication
(10) Pub. No.: US 2012/0313843 A1
(43) Pub. Date: Dec. 13, 2012

(54) DISPLAY DEVICE

(75) Inventors: Naoko Kondoh, Osaka-shi (JP); Hiroyuki Furukawa, Osaka-shi (JP); Kazuyoshi Yoshiyama, Osaka-shi (JP); Shinji Nakagawa, Osaka-shi (JP); Yasuhiro Yoshida, Osaka-shi (JP)

(73) Assignee: SHARP KABUSHIKI KAISHA, Osaka-shi, Osaka (JP)

(21) Appl. No.: 13/578,744

(22) PCT Filed: Feb. 15, 2011
(86) PCT No.: PCT/JP2011/053158

§ 371 Date: Aug. 13, 2012

(30) Foreign Application Priority Data
Feb. 18, 2010 (JP) 2010-034097

(51) Int. Cl. G09G 5/02

(52) U.S. Cl. 345/55

(57) ABSTRACT

A display device according to the present invention includes a plurality of pixels arranged in a matrix. Each of the plurality of pixels is formed of four or five types of sub pixels that display different colors from each other. In each pixel, a first sub pixel that displays a color having the highest luminance and a second sub pixel that displays a color having the second highest luminance are located so as not to be adjacent to each other. The four or five types of sub pixels include a plurality of display units, each of which is capable of displaying a specific color and is formed of one sub pixel or two or more continuous sub pixels. In the display device according to the present invention, when an input image has a resolution higher than a display resolution defined by a total number of the plurality of pixels, each of the plurality of display units is usable as a virtual pixel for providing display. According to the present invention, a multiple primary color display device which suppresses the decline of display quality even when the resolution of an input image is higher than the resolution of the display device is provided.

### TECHNICAL FIELD

The present invention relates to a display device, and specifically to a multiple primary color display device for providing display by use of four or five primary colors.

### BACKGROUND ART

When image data input to a display device has a resolution different from that of the display device, the input image is displayed in an enlarged or reduced state. Namely, when the number of pixels of the input image is different from the total number of pixels of the display device, the display device displays the image with a number of pixels different from the number of pixels of the input image.

Known techniques for enlarging or reducing an input image include a bilinear technique, a bicubic technique and the like. According to these techniques, pixels which are not present in an input image are interpolated by performing averaging or weighted averaging of values of surrounding pixels, or pixels of an input image are decimated by a computation such as filter processing or the like, so that an output value corresponding to each pixel of the display device is obtained.

In the meantime, in order to broaden the color reproduction range of a display device, techniques for increasing the number of primary colors used for display have recently been proposed. In a general display device, one pixel is formed of three types of sub pixels for displaying red, green and blue, which are the three primary colors of light, and this enables color display. However, a conventional display device has a problem that the color reproduction range is narrow. When the color reproduction range is narrow, a part of a object color (color of various objects present in the natural world; see Non-patent Document 1) cannot be displayed.

Patent Document 1 discloses a liquid crystal display device in which one pixel is formed of four types of sub pixels which are a red sub pixel that displays red, a green sub pixel that displays green, a blue sub pixel that displays blue, and a yellow sub pixel that displays yellow. In this liquid crystal display device, color display is provided by mixing four primary colors of red, green, blue and yellow, which are displayed by the four types of sub pixels.

By increasing the number of primary colors used for display, namely, by providing display by use of four or more primary colors, the color reproduction range can be broadened as compared with that provided by a conventional display device which provides display by use of three primary colors. A display device which provides display by use of four or more primary colors is referred to as a “multiple primary color display device”.

### CITATION LIST

### Patent Literature

Patent Document 1: Japanese Laid-Open Patent Publication No. 2001-209047

### NON-PATENT LITERATURE

Non-patent Document 1: M. R. Pointer, “The gamut of real surface colours,” Color Research and Application, Vol. 5, No. 3, pp. 145-155 (1980)

### SUMMARY OF INVENTION

### Technical Problem

When an input image is enlarged or reduced by a conventional technique, information on profiles, colors or the like included in original image data cannot be completely reproduced. For example, when an input image is reduced, the number of pixels is decreased in accordance with the resolution on the output side (total number of pixels of the display device). As a result, color blurring or the like occurs and thus the image quality is declined.

In general, for performing reduction processing, an input signal is processed with a low-pass-filter (LPF) and then is subjected to sampling processing in accordance with the resolution on the output side (on the display device side). The LPF is designed so as to have a blocking characteristic which is ½ of the maximum value of frequency at which display can be provided on the output side (on the display device side). Due to such a blocking characteristic of the LPF, the post-reduction image is blurred or deformed. Such a blur or deformation is theoretical and cannot be avoided by any conventional technique.

As described above, when an input image is reduced by a conventional technique, the display quality is declined. No technique for suppressing such a decline of display quality has been proposed. Therefore, naturally, no preferable technique for reducing an input image by a multiple primary color display device has been proposed.

The present invention made in light of the above-described problem has an object of providing a multiple primary color display device for suppressing such a decline of display quality even when the resolution of an input image is higher than the resolution of the display device.

### Solution to Problem

A display device according to the present invention includes a plurality of pixels arranged in a matrix including a plurality of rows and a plurality of columns, each of the plurality of pixels being formed of four or five types of sub pixels that display different colors from each other. In each of the plurality of pixels, a first sub pixel that displays a color having the highest luminance among the colors displayed by the four or five types of sub pixels, and a second sub pixel that displays a color having the second highest luminance, are located so as not to be adjacent to each other; the four or five types of sub pixels include a plurality of display units, each of which is capable of displaying a specific color and is formed of one sub pixel or two or more continuous sub pixels; and when an input image has a resolution higher than a display resolution defined by a total number of the plurality of pixels, each of the plurality of display units is usable as a virtual pixel for providing display.

In a preferable embodiment, in each of the plurality of pixels, the four or five types of sub pixels are arranged in one row by a plurality of columns; and when the resolution of the input image is higher than the display resolution, between in a first case where colors of two pixels continuous along a row direction of the input image are the specific color and black from left and in a second case where the colors of such two pixels are black and the specific color from left, luminances of the four or five types of sub pixels forming a pixel, among the plurality of pixels of the display device, corresponding to the two pixels of the input image are at least partially different.

In a preferable embodiment, each of the plurality of display units is formed of one sub pixel or two or more sub pixels continuous in one pixel; in the first case, among the first sub pixel and the second sub pixel, one sub pixel located relatively leftward in one pixel has a higher luminance than that of the other sub pixel located relatively rightward in the pixel; and in the second case, among the first sub pixel and the second sub pixel, one sub pixel located relatively rightward in one pixel has a higher luminance than that of the other sub pixel located relatively leftward in the pixel.

In a preferable embodiment, one display unit among the plurality of display units is formed of two or more sub pixels located over two pixels; in the first case, among the first sub pixel and the second sub pixel, one sub pixel located relatively rightward in one pixel has a higher luminance than that of the other sub pixel located relatively leftward in the pixel; and in the second case, among the first sub pixel and the second sub pixel, one sub pixel located relatively leftward in one pixel has a higher luminance than that of the other sub pixel located relatively rightward in the pixel.

In a preferable embodiment, each of the plurality of pixels is formed of four types of sub pixels that display different colors from each other.

In a preferable embodiment, the four types of sub pixels are a red sub pixel that displays red, a green sub pixel that displays green, a blue sub pixel that displays blue, and a yellow sub pixel that displays yellow.

In a preferable embodiment, the first sub pixel that displays the color having the highest luminance is the yellow sub pixel; and the second sub pixel that displays the color having the second highest luminance is the green sub pixel.

In a preferable embodiment, when the specific color is white, the plurality of display units are a first display unit formed of the red sub pixel, the green sub pixel and the blue sub pixel, and a second display unit formed of the blue sub pixel and the yellow sub pixel.

In a preferable embodiment, when the specific color is yellow, the plurality of display units are a first display unit formed of the red sub pixel and the green sub pixel, and a second display unit formed of the yellow sub pixel.

In a preferable embodiment, each of the plurality of pixels is formed of five types of sub pixels that display different colors from each other.

In a preferable embodiment, the five types of sub pixels are a red sub pixel that displays red, a green sub pixel that displays green, a blue sub pixel that displays blue, a cyan sub pixel that displays cyan, and a yellow sub pixel that displays yellow.

In a preferable embodiment, the first sub pixel that displays the color having the highest luminance is the yellow sub pixel; and the second sub pixel that displays the color having the second highest luminance is the cyan sub pixel.

In a preferable embodiment, when the specific color is white, the plurality of display units are a first display unit formed of the red sub pixel and the cyan sub pixel, and a second display unit formed of the blue sub pixel and the yellow sub pixel.

### Advantageous Effects of Invention

The present invention provides a multiple primary color display device for suppressing the decline of display quality even when the resolution of an input image is higher than the resolution of the display device.

### BRIEF DESCRIPTION OF DRAWINGS

FIG. 1 is a block diagram schematically showing a liquid crystal display device 100 in a preferable embodiment according to the present invention.

FIG. 2 shows a sub pixel arrangement of the liquid crystal display device 100.

FIG. 3 shows a sub pixel arrangement of the liquid crystal display device 100.

FIGS. 4(a) and (b) show a first display unit DU1 and a second display unit DU2 included in four types of sub pixels of the liquid crystal display device 100.

FIGS. 5(a) and (b) show a first display unit DU1 and a second display unit DU2 included in the four types of sub pixels of the liquid crystal display device 100.

FIG. 6(a) shows two pixels P1′ and P2′ continuous along a row direction of an input image; FIG. 6(b) shows a lit state of a pixel P when general reduction processing is performed by a liquid crystal display device for providing display by use of three primary colors; and FIG. 6(c) shows a lit state of a pixel P when reduction processing is performed by the liquid crystal display device 100.

FIG. 7(a) shows an example of arrangement in which a yellow sub pixel Ye and a green sub pixel G are not adjacent to each other; and FIG. 7(b) shows an example of arrangement in which the yellow sub pixel Ye and the green sub pixel G are adjacent to each other.

FIG. 8(a) shows colors of two pixels P1′ and P2′ of an input image; and FIG. 8(b) shows a lit state of each sub pixel of the liquid crystal display device 100.

FIG. 9(a) shows colors of two pixels P1′ and P2′ of an input image; and FIG. 9(b) shows a lit state of each sub pixel of the liquid crystal display device 100.

FIG. 10(a) shows a sub pixel arrangement of the liquid crystal display device 100, and FIGS. 10(b) and (c) show a first display unit DU1 and a second display unit DU2 included in the four types of sub pixels of the liquid crystal display device 100.

FIG. 11(a) shows colors of two pixels P1′ and P2′ of an input image; and FIG. 11(b) shows a lit state of each sub pixel of the liquid crystal display device 100.

FIG. 12(a) shows colors of two pixels P1′and P2′ of an input image; and FIG. 12(b) shows a lit state of each sub pixel of the liquid crystal display device 100.

FIG. 13(a) shows colors of two pixels P1′ and P2′ of an input image; and FIG. 13(b) shows a lit state of each sub pixel of the liquid crystal display device 100.

FIG. 14(a) shows colors of two pixels P1′ and P2′ of an input image; and FIG. 14(b) shows a lit state of each sub pixel of the liquid crystal display device 100.

FIG. 15 is a block diagram schematically showing a liquid crystal display device 200 in a preferable embodiment according to the present invention.

FIG. 16 shows a sub pixel arrangement of the liquid crystal display device 100.

FIG. 17 shows a sub pixel arrangement of the liquid crystal display device 100.

FIGS. 18(a) and (b) show a first display unit DU1 and a second display unit DU2 included in five types of sub pixels of the liquid crystal display device 200.

FIG. 19(a) shows colors of two pixels P1′ and P2′ of an input image; and FIG. 19(b) shows a lit state of each sub pixel of the liquid crystal display device 200.

FIG. 20(a) shows colors of two pixels P1′ and P2′ of an input image; and FIG. 20(b) shows a lit state of each sub pixel of the liquid crystal display device 200.

FIG. 21(a) shows a sub pixel arrangement of the liquid crystal display device 200, and FIGS. 21(b) and (c) show a first display unit DU1 and a second display unit DU2 included in the five types of sub pixels of the liquid crystal display device 200.

FIG. 22(a) shows colors of two pixels P1′ and P2′ of an input image; and FIG. 22(b) shows a lit state of each sub pixel of the liquid crystal display device 200.

FIG. 23(a) shows colors of two pixels P1′ and P2′ of an input image; and FIG. 23(b) shows a lit state of each sub pixel of the liquid crystal display device 200.

FIG. 24 is a block diagram showing an example of specific structure of a resolution conversion device 10 included in the liquid crystal display device 100.

FIG. 25 is a block diagram showing an example of specific structure of a horizontal resolution conversion section 12 included in the resolution conversion device 10.

FIG. 26 schematically shows specific processing performed on pixels of even-numbered columns of an input image and pixels of odd-numbered columns of the input image.

FIG. 27 is a block diagram showing another example of specific structure of the horizontal resolution conversion section 12 included in the resolution conversion device 10.

FIG. 28 schematically shows processing performed by a sub pixel rendering section 12i included in the horizontal resolution conversion section 12.

### DESCRIPTION OF EMBODIMENTS

Hereinafter, with reference to the drawings, embodiments of the present invention will be described. In the following, a liquid crystal display device will be described as an example, but the present invention is not limited to a liquid crystal display device and is preferably usable for other types of display devices including an organic EL display device.

### Embodiment 1

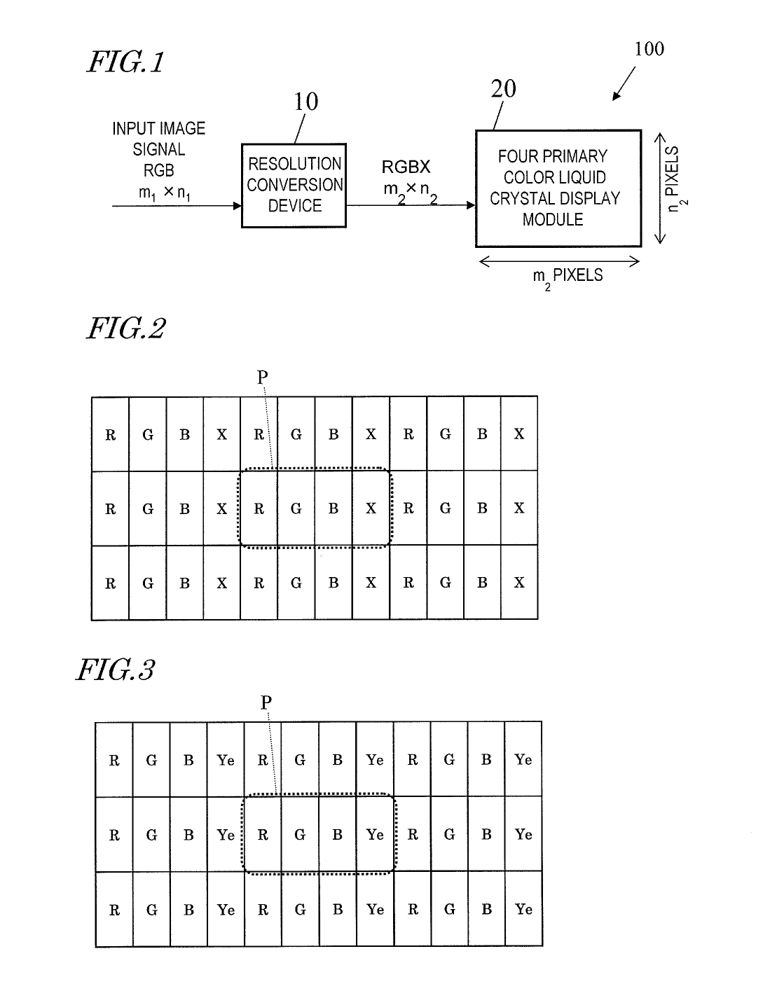

FIG. 1 shows a liquid crystal display device 100 in this embodiment. As shown in FIG. 1, the liquid crystal display device 100 is a multiple primary color display device including a resolution conversion device 10 and a four primary color liquid crystal display module 20 and providing display by use of four primary colors.

The four primary color liquid crystal display module 20 includes a liquid crystal display panel, a gate driver, a source driver, a timing controller, a backlight device (illumination device) and the like which are not shown. The liquid crystal display panel includes a plurality of pixels arranged in a matrix including a plurality of rows and a plurality of columns.

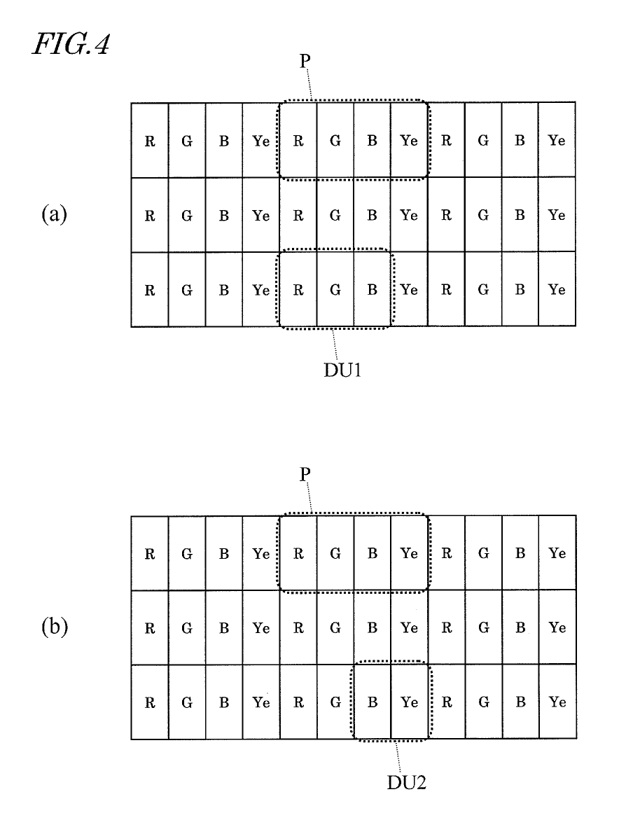

FIG. 2 shows a specific pixel structure (sub pixel arrangement) of the liquid crystal display panel. As shown in FIG. 2, the plurality of pixels P are each formed of four types of sub pixels that display different colors from each other. The four types of sub pixels are, specifically, a red sub pixel R that displays red, a green sub pixel G that displays green, a blue sub pixel B that displays blue, and a sub pixel X that displays a color different from any of red, green and blue. In each pixel P, these four types of sub pixels are arranged in one row by four columns.

In this specification, unless otherwise specified, a total number of the plurality of pixels P of the liquid crystal display panel is referred to as a “display resolution”. In the case where the plurality of pixels P are arranged in m pixels in the row direction by n pixels in the column direction, the display resolution is expressed as “m×n”. In this specification, a minimum display unit of an input image is also referred to as a “pixel”, and a total number of pixels of an input image is referred to as a “resolution of the input image”. In this case also, the resolution of the input image including m pixels in the row direction and n pixels in the column direction is expressed as “m×n”.

The resolution conversion device 10 shown in FIG. 1 converts the resolution (m₁×n₁) of an image signal input from an external device such that the resolution (m₁×n₁) matches a display resolution (m₂×n₂) of the four primary color liquid crystal display module 20. The resolution conversion device also converts an image signal corresponding to three primary colors (red, green and blue) into a multiple primary color signal corresponding to four primary colors (red, green and blue displayed by the red sub pixel R, the green sub pixel G and the blue sub pixel B, and a color displayed by the sub pixel X). A more specific structure of the resolution conversion device 10 will be described later.

In the liquid crystal display device 100 in this embodiment, the four types of sub pixels are located in each of the plurality of pixels P, such that a sub pixel that displays a color having the highest luminance among the colors displayed by the four types of sub pixels (referred to as a “first sub pixel” for the sake of convenience) and a sub pixel that displays a color having the second highest luminance (referred to as a “second sub pixel” for the sake of convenience) are not adjacent to each other (namely, such that these sub pixels have at least one sub pixel located therebetween). FIG. 2 shows an example of sub pixel arrangement in the case where the first sub pixel is the green sub pixel G and the second sub pixel is the sub pixel X. In the example shown in FIG. 2, in each pixel P, the four types of sub pixels are located in the order of the red sub pixel R, the green sub pixel G, the blue sub pixel B and the sub pixel X from left to right. The green sub pixel G and the sub pixel X are not adjacent to each other.

In the liquid crystal display device 100 in this embodiment, the four types of sub pixels include a plurality of display units, each of which can display a specific color and is formed of one sub pixel or two or more continuous sub pixels. Namely, for the specific color, the four types of sub pixels can define a plurality of display units each having a size intermediate between size of the pixel and the size of the sub pixel (as described later, one of the plurality of display units may have the same size as that of the sub pixel). For example, in the case where the sub pixel X displays a color complementary to red, green or blue, a display unit formed of the red sub pixel R, the green sub pixel G and the blue sub pixel B, and a display unit formed of the sub pixel X and a sub pixel that displays a color complementary to the color displayed by the sub pixel X, are defined for white.

In the liquid crystal display device 100 in this embodiment, in the case where the resolution of an input image is higher than the display resolution (namely, in the case where the total number of pixels of the input image is larger than the total number of the plurality of pixels P of the liquid crystal display panel), each of the plurality of display units can be used as a virtual pixel for providing display. Therefore, the visual resolution can be improved. In the liquid crystal display device 100 in this embodiment, the first sub pixel that displays a color having the highest luminance (namely, the color having the highest luminance at the maximum gray scale level) and the second sub pixel that displays a color having the second highest luminance (namely, the color having the second highest luminance at the maximum gray scale level) are located so as not to be adjacent to each other in the pixel P. Therefore, the spatial frequency of luminance distribution can be higher than that in the case where the first sub pixel and the second sub pixel are adjacent to each other. As a result, in the liquid crystal display device 100, two adjacent virtual pixels are prevented from being visually recognized as being merged.

Hereinafter, a form of display of the liquid crystal display device 100 will be described in more detail with specific examples of the sub pixel X. FIG. 3 shows an example of sub pixel arrangement in the case where the sub pixel X is a yellow sub pixel Ye that displays yellow. In the example shown in FIG. 3, each of the plurality of pixels P is formed of the red sub pixel R, the green sub pixel G, the blue sub pixel B and the yellow sub pixel Ye. In each pixel P, the four types of sub pixels are located in the order of the red sub pixel R, the green sub pixel G, the blue sub pixel B and the yellow sub pixel Ye from left to right.

Table 1 shows an example of Y values of the red sub pixel R, the green sub pixel G, the blue sub pixel B and the yellow sub pixel Ye (Y values when these sub pixels are lit up at the maximum gray scale level). The Y value of each sub pixel is represented as a percentage value with respect to 100%, where the Y value of the pixel P when white is displayed is 100%.

TABLE 1

| Sub pixel | R | G | B | Ye |
|---|---|---|---|---|
| Y value (%) | 16 | 32 | 5 | 47 |

As can be seen from Table 1, the Y value of the yellow sub pixel Ye is highest, and the Y value of the green sub pixel G is second highest. Namely, among the four primary colors displayed by the four types of sub pixels, yellow displayed by the yellow sub pixel Ye has the highest luminance (brightness), and green displayed by the green sub pixel G has the second highest luminance (brightness). As shown in FIG. 3, the yellow sub pixel Ye that displays yellow having the highest luminance and the green sub pixel G that displays green having the second highest luminance are not adjacent to each other.

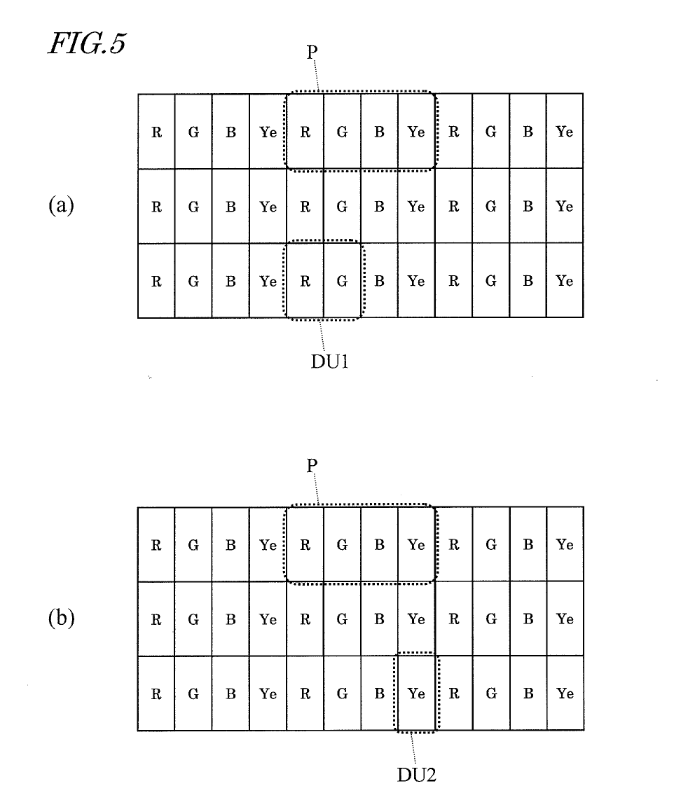

The four types of sub pixels include, as a plurality of display units that display white, a first display unit DU1 as shown in FIG. 4(a) formed of the red sub pixel R, the green sub pixel G and the blue sub pixel B, and a second display unit DU2 as shown in FIG. 4(b) formed of the blue sub pixel B and the yellow sub pixel Ye. The first display unit DU1 is formed of the red sub pixel R, the green sub pixel G and the blue sub pixel B for displaying red, green and blue, which are the three primary colors of light, and thus can display white. The second display unit DU2 is formed of the blue sub pixel B and the yellow sub pixel Ye for displaying blue and yellow, which are complementary to each other, and thus also can display white.

The four types of sub pixels include, as a plurality of display units that display yellow, a first display unit DU1 as shown in FIG. 5(a) formed of the red sub pixel R and the green sub pixel G, and a second display unit DU2 as shown in FIG. 5(b) formed of the yellow sub pixel Ye. The first display unit DU1 is formed of the red sub pixel R and the green sub pixel G for displaying red and green, which become yellow when being mixed, and thus can display yellow. The second display unit DU2 is formed of only the yellow sub pixel Ye for displaying yellow, and thus also can display yellow.

As described above, the four types of sub pixels forming each pixel P include a plurality of display units, each of which can display a specific color. Therefore, for providing display in a reduced state, each of the plurality of display units can be used as a virtual pixel. As a result, the visual resolution can be improved.

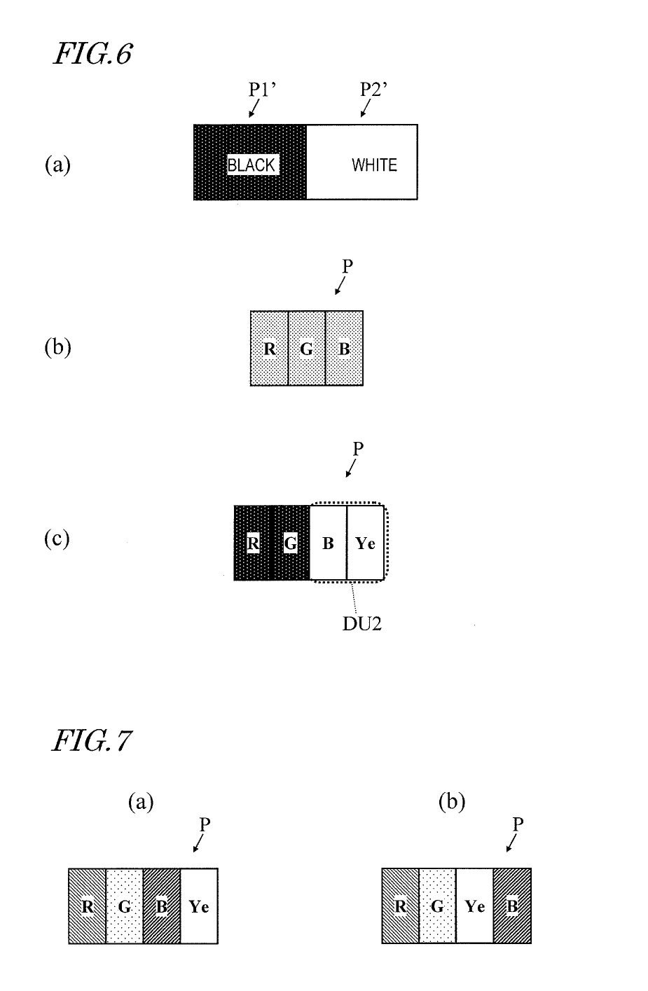

For example, it is assumed that an input image of white stripes extending in the column direction on a black background is to be displayed in a state of being reduced to ½. The white stripes each have a width of one pixel and are located at an interval of one pixel. In this case, only one of the first display unit DU1 and the second display unit DU2 shown in FIGS. 4(a) and (b) is lit up. In this manner, the display can be provided with substantially the same resolution as that of the input image. This effect will be described specifically with reference to FIGS. 6(a), (b) and (c).

FIG. 6(a) shows two pixels P1′ and P2′ which are continuous along the row direction of the input image. As shown in FIG. 6(a), the color of the left pixel P1′ is black and the color of the right pixel P2′ is white.

FIG. 6(b) shows a lit state of the pixel P corresponding to the two pixels P1′ and P2′ of the input image when the input image is reduced in a general technique in a liquid crystal display device for providing display by use of three primary colors (namely, a liquid crystal display device in which each pixel is formed of the red sub pixel R, the green sub pixel G and the blue sub pixel B). As shown in FIG. 6(b), the red sub pixel R, the green sub pixel G and the blue sub pixel B are all lit up at the same intermediate scale level and thus the pixel P displays gray as a whole. This occurs because when an image is reduced by a general technique such as the bilinear technique or the like, the luminance of the pixel P becomes the average of the luminance of the pixel P1′ and the luminance of the pixel P2′ of the input image. Therefore, when the above-described input image of stripes is reduced to ½ for display, an entirely gray image is provided.

FIG. 6(c) shows a lit state of a pixel P corresponding to the two pixels P1′ and P2′ of the input image when the input image is reduced in the liquid crystal display device 100 in this embodiment. As shown in FIG. 6(c), the red sub pixel R and the green sub pixel G are not lit up (namely, these sub pixels display the minimum gray scale level), whereas the blue sub pixel B and the yellow sub pixel Ye forming the second display unit DU2 are lit up at the maximum gray scale level. Therefore, the left half of the pixel P displays black as a virtual pixel, and the right half of the pixel P displays white as a virtual pixel. As a result, the visual resolution is improved, and thus the display can be provided with a resolution higher than (specifically, twice) the display resolution of the liquid crystal display device 100 (defined by the total number of the plurality of pixels P).

In the example shown in FIG. 3, the yellow sub pixel (first sub pixel) Ye that displays the color having the highest luminance and the green sub pixel (second sub pixel) G that displays the color having the second highest luminance are located so as not be adjacent to each other. An effect provided by this will be described with reference to FIGS. 7(a) and (b).

FIG. 7(a) shows an arrangement in which the yellow sub pixel Ye and the green sub pixel G are not adjacent to each other. FIG. 7(b) shows an arrangement in which the yellow sub pixel Ye and the green sub pixel G are adjacent to each other. In FIGS. 7(a) and (b), each sub pixel displays the same gray scale level. However, in the arrangement shown in FIG. 7(b), the yellow sub pixel Ye that displays the color having the highest luminance and the green sub pixel G that displays the color having the second highest luminance are adjacent to each other. Therefore, when high resolution display is provided by use of a display unit having an intermediate size as described above, two adjacent virtual pixels are recognized as being merged. By contrast, in the arrangement shown in FIG. 7(a), the yellow sub pixel Ye that displays the color having the highest luminance and the green sub pixel G that displays the color having the second highest luminance are not adjacent to each other. Therefore, the spatial frequency of luminance distribution is increased, and thus such a problem is prevented.

As described above, in the liquid crystal display device 100 in this embodiment, when the resolution of the input image is higher than the display resolution, a specific color for which a plurality of display units may be defined can be displayed by using each of the display units as a virtual pixel. Therefore, between in the case where the colors of two pixels continuous along the row direction of the input image are the specific color and black from left and in the case where the colors of such two pixels are black and the specific color from left, the luminances of the four types of sub pixels forming the pixel P corresponding to the two pixels of the input image are at least partially different. Namely, the output of the sub pixel unit is different between in the former case and in the latter case.

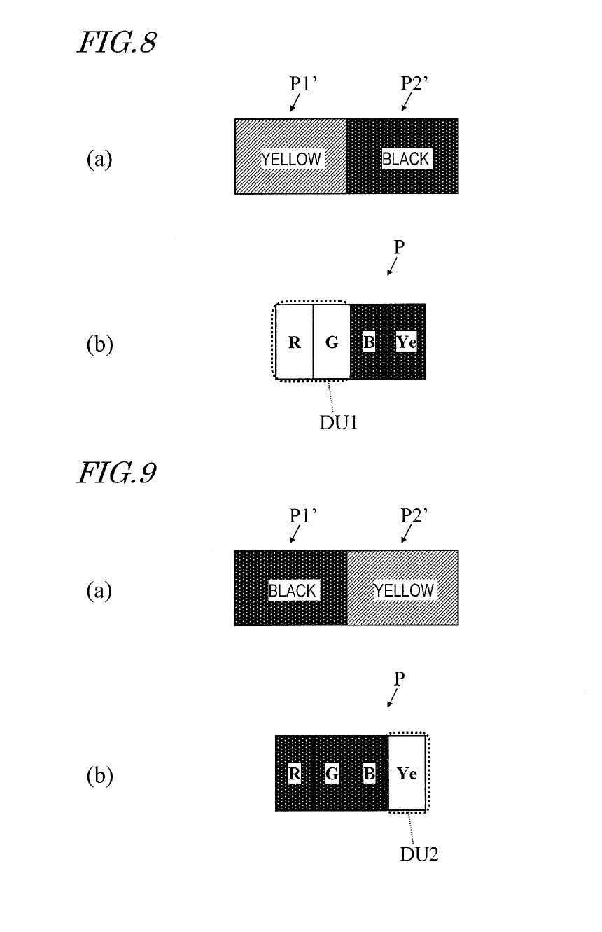

For example, in FIG. 8(a), the colors of two pixels P1′ and P2′ of an input image are yellow and black from left. In this case, as shown in FIG. 8(b), in the pixel P of the liquid crystal display device 100 corresponding to these two pixels, the red sub pixel R and the green sub pixel G (sub pixels forming the first display unit DU1 for yellow) are lit up, whereas the blue sub pixel B and the yellow sub pixel Ye are left unlit. By contrast, in FIG. 9(a), the colors of two pixels P1′ and P2′ of an input image are black and yellow from left. In this case, as shown in FIG. 9(b), in the pixel P of the liquid crystal display device 100 corresponding to these two pixels, the yellow sub pixel Ye (sub pixel forming the second display unit DU2 for yellow) is lit up, whereas the red sub pixel R, the green sub pixel G and the blue sub pixel B are left unlit.

As can be seen from a comparison between the case shown in FIGS. 8(a) and (b) and the case shown in FIGS. 9(a) and (b), in the former case, among the first sub pixel and the second sub pixel (the yellow sub pixel Ye and the green sub pixel G), the green sub pixel G, which is located relatively leftward in one pixel, has a higher luminance than that of the yellow sub pixel Ye, which is located relatively rightward in the pixel. By contrast, in the latter case, the yellow sub pixel Ye, which is located relatively rightward in one pixel, has a higher luminance than that of the green sub pixel G, which is located relatively leftward in the pixel.

In the pixel structure (sub pixel arrangement) shown in FIGS. 3 through 5, the plurality of display units for a specific color are each formed of one sub pixel (second display unit DU2 for yellow) or two or more sub pixels continuous in one pixel (first display unit DU1 and the second display unit DU2 for white, first display unit DU1 for yellow). However, the present invention is not limited to such a sub pixel arrangement.

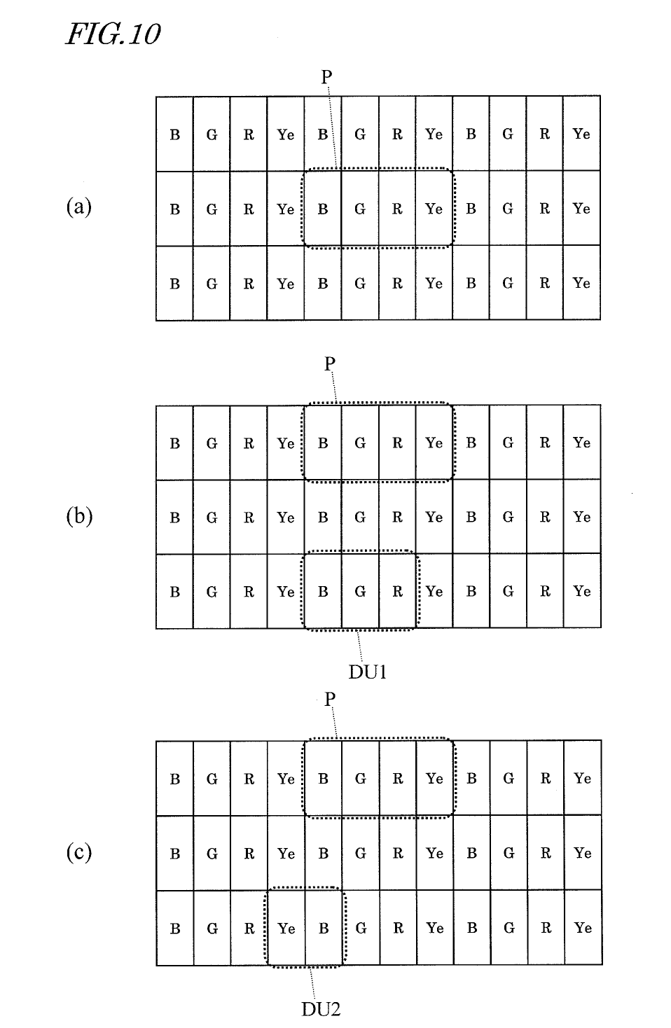

FIG. 10(a) shows another example of sub pixel arrangement. In the example shown in FIG. 10(a), in each pixel P, the four types of sub pixels are located in the order of the blue sub pixel B, the green sub pixel G, the red sub pixel R and the yellow sub pixel Ye from left to right. In this arrangement also, the yellow sub pixel Ye that displays yellow having the highest luminance and the green sub pixel G that displays green having the second highest luminance are not adjacent to each other.

The four types of sub pixels located as shown in FIG. 10(a) include, as a plurality of display units that displays white, a first display unit DU1 as shown in FIG. 10(b) formed of the red sub pixel R, the green sub pixel G and the blue sub pixel B, and a second display unit DU2 as shown in FIG. 10(c) formed of the blue sub pixel B and the yellow sub pixel Ye. The display unit DU2 shown in FIG. 10(c) is formed of a plurality of sub pixels continuous over two pixels P. In this manner, among a plurality of display units for a specific color, one display unit may be located over two pixels P.

Even when the arrangement shown in FIG. 10 is adopted, the output of the sub pixel unit is different between in the case where the colors of two pixels continuous along the row direction of the input image are the specific color and black from left and in the case where the colors of such two pixels are black and the specific color from left.

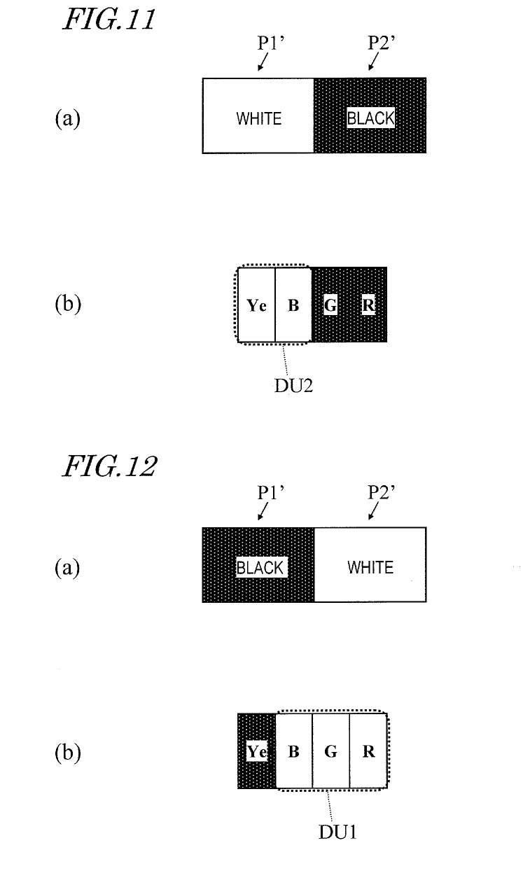

For example, in FIG. 11(a), the colors of two pixels P1′ and P2′ of an input image are white and black from left. In this case, as shown in FIG. 11(b), the blue sub pixel B and the yellow sub pixel Ye (sub pixels forming the second display unit DU2) are lit up, whereas the red sub pixel R and the green sub pixel G are left unlit. By contrast, in FIG. 12(a), the colors of two pixels P1′ and P2′ of an input image are black and white from left. In this case, as shown in FIG. 12(b), the red sub pixel R, the green sub pixel G and the blue sub pixel B (sub pixels forming the first display unit DU1) are lit up, whereas the yellow sub pixel Ye is left unlit.

As can be seen from a comparison between the case shown in FIGS. 11(a) and (b) and the case shown in FIGS. 12(a) and (b), in the former case, among the first sub pixel and the second sub pixel (the yellow sub pixel Ye and the green sub pixel G), the yellow sub pixel Ye, which is located relatively rightward in one pixel (see FIG. 10), has a higher luminance than that of the green sub pixel G, which is located relatively leftward in the pixel. By contrast, in the latter case, the green sub pixel G, which is located relatively leftward in one pixel, has a higher luminance than that of the yellow sub pixel Ye, which is located relatively rightward in the pixel.

A color for which a plurality of display units are not defined by the four types of sub pixels cannot be displayed by use of a virtual pixel. However, even in this case, a sub pixel for displaying a color closest to such a color may be lit up while the sub pixel(s) in the vicinity of such a sub pixel is(are) lit up in a supplementary manner. In this way, a difference in the luminance distribution can be represented. For example, for green, a difference in the luminance distribution can be represented to a certain degree by lighting up the green sub pixel G while lighting up the sub pixel(s) in the vicinity of the green sub pixel G in a supplementary manner. In this case also, the output of the sub pixel unit is different between in the case where the colors of two pixels continuous along the row direction of an input image are green and black from left and in the case where the colors of such two pixels are black and green from left.

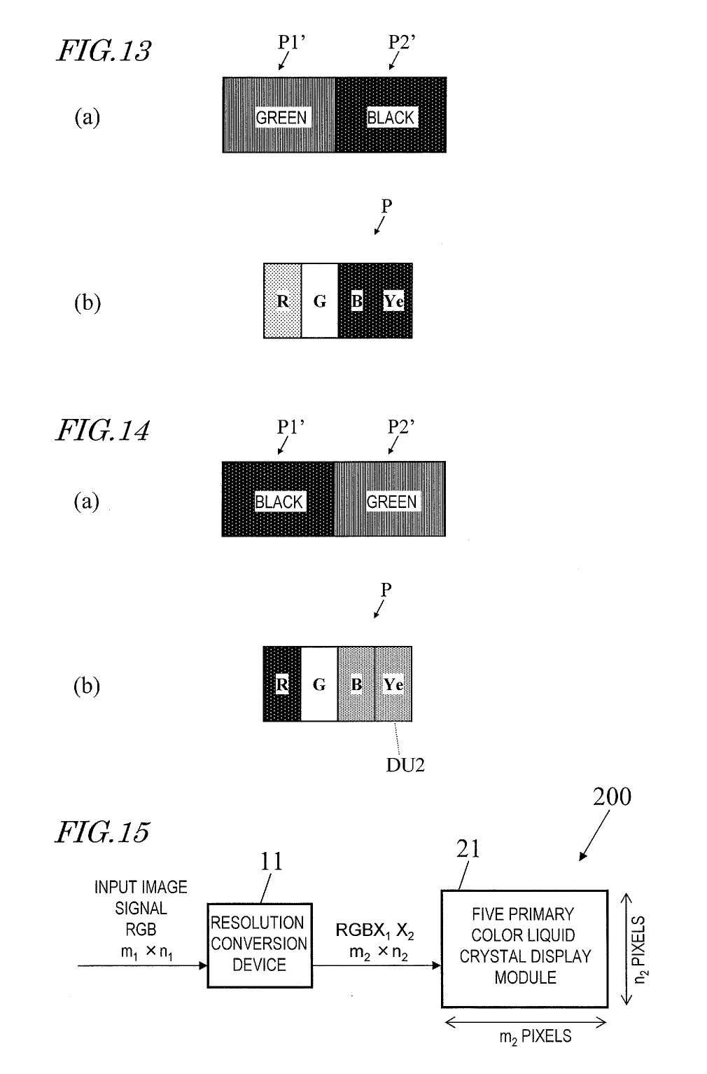

In FIG. 13(a), the colors of two pixels P1′ and P2′ of an input image are green and black from left. In this case, as shown in FIG. 13(b), the green sub pixel G is lit up while the red sub pixel R left to the green sub pixel G is lit up in a supplementary manner. By contrast, in FIG. 14(a), the colors of two pixels P1′ and P2′ of an input image are black and green from left. In this case, as shown in FIG. 14(b), the green sub pixel G is lit up while the blue sub pixel B and the yellow sub pixel Ye right to the green sub pixel G are lit up in a supplementary manner.

In this embodiment, the sub pixel X that displays a color different from any of red, green and blue is the yellow sub pixel Ye. However, the present invention is not limited to this. The sub pixel X may be a cyan sub pixel that displays cyan or a magenta sub pixel that displays magenta.

### Embodiment 2

FIG. 15 shows a liquid crystal display device 200 in this embodiment. As shown in FIG. 15, the liquid crystal display device 200 is a multiple primary color display device including a resolution conversion device 11 and a five primary color liquid crystal display module 21 and providing display by use of five primary colors.

The five primary color liquid crystal display module 21 includes a liquid crystal display panel, a gate driver, a source driver, a timing controller, a backlight device (illumination device) and the like which are not shown. The liquid crystal display panel includes a plurality of pixels arranged in a matrix including a plurality of rows and a plurality of columns.

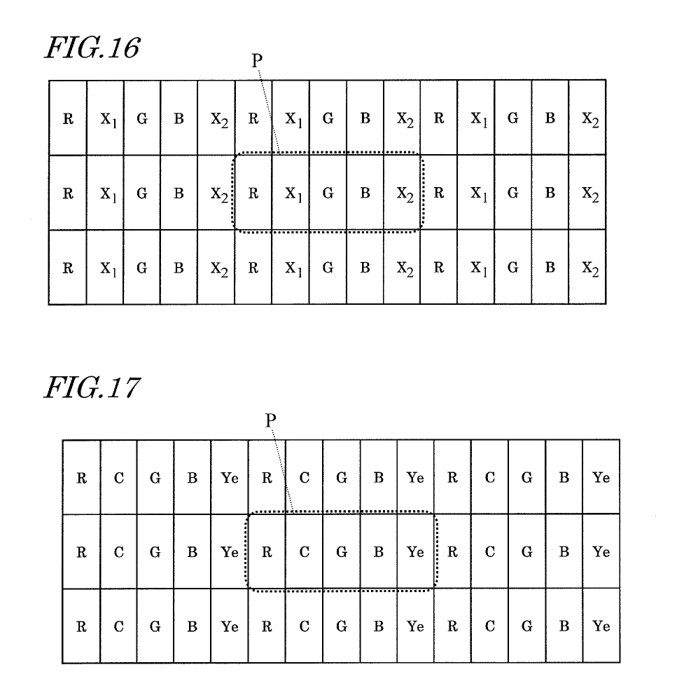

FIG. 16 shows a specific pixel structure (sub pixel arrangement) of the liquid crystal display panel. As shown in FIG. 16, the plurality of pixels P are each formed of five types of sub pixels that display different colors from each other. The five types of sub pixels are, specifically, a red sub pixel R that display red, a green sub pixel G that display green, a blue sub pixel B that display blue, and a sub pixel X₁ and a sub pixel X₂, each of that displays a color different from any of red, green and blue. In each pixel P, these five types of sub pixels are arranged in one row by five columns.

The resolution conversion device 11 shown in FIG. 15 converts the resolution (m₁×n₁) of an image signal input from an external device such that the resolution (m₁×n₁) matches a display resolution (m₂×n₂) of the five primary color liquid crystal display module 21. The resolution conversion device also converts an image signal corresponding to three primary colors (red, green and blue) into a multiple primary color signal corresponding to five primary colors (red, green and blue displayed by the red sub pixel R, the green sub pixel G and the blue sub pixel B, a color displayed by the sub pixel X₁ and a color displayed by the sub pixel X₂).

In the liquid crystal display device 200 in this embodiment, the five types of sub pixels are located in each of the plurality of pixels P, such that a sub pixel that displays a color having the highest luminance among the colors displayed by the five types of sub pixels (“first sub pixel”) and a sub pixel that displays a color having the second highest luminance (“second sub pixel”) are not adjacent to each other (namely, such that these sub pixels have at least one sub pixel located therebetween). FIG. 16 shows an example of sub pixel arrangement in the case where the first sub pixel is the sub pixel X₂ and the second sub pixel is the sub pixel X₁. In the example shown in FIG. 16, in each pixel P, the five types of sub pixels are located in the order of the red sub pixel R, the sub pixel X₁, the green sub pixel G, the blue sub pixel B and the sub pixel X₂ from left to right. The sub pixel X₁, and the sub pixel X₂ are not adjacent to each other.

In the liquid crystal display device 200 in this embodiment, the five types of sub pixels include a plurality of display units, each of which can display a specific color and is formed of one sub pixel or two or more continuous sub pixels. Namely, for the specific color, the five types of sub pixels can define a plurality of display units each having a size intermediate between size of the pixel and the size of the sub pixel (as described later, one of the plurality of display units may have the same size as that of the sub pixel).

In the liquid crystal display device 200 in this embodiment also, in the case where the resolution of an input image is higher than the display resolution (namely, in the case where the total number of pixels of the input image is larger than the total number of the plurality of pixels P of the liquid crystal display panel), each of the plurality of display units can be used as a virtual pixel for providing display. Therefore, the visual resolution can be improved. In the liquid crystal display device 200 in this embodiment, the first sub pixel that displays a color having the highest luminance and the second sub pixel that displays a color having the second highest luminance are located so as not to be adjacent to each other in the pixel P. Therefore, the spatial frequency of luminance distribution can be higher than that in the case where the first sub pixel and the second sub pixel are adjacent to each other. As a result, in the liquid crystal display device 200, two adjacent virtual pixels are prevented from being visually recognized as being merged.

Hereinafter, a form of display of the liquid crystal display device 200 will be described in more detail with specific examples of the sub pixel X₁ and the sub pixel X₂. FIG. 17 shows an example of sub pixel arrangement in the case where the sub pixel X₁ is a cyan sub pixel C that displays cyan and the sub pixel X₂ is the yellow sub pixel Ye that displays yellow. In the example shown in FIG. 17, each of the plurality of pixels P is formed of the red sub pixel R, the green sub pixel G, the blue sub pixel B, the cyan sub pixel C and the yellow sub pixel Ye. In each pixel P, the five types of sub pixels are located in the order of the red sub pixel R, the cyan sub pixel C, the green sub pixel G, the blue sub pixel B and the yellow sub pixel Ye from left to right.

Table 2 shows an example of Y values of the red sub pixel R, the green sub pixel G, the blue sub pixel B, the cyan sub pixel C and the yellow sub pixel Ye (Y values when these sub pixels are lit up at the maximum gray scale level). The Y value of each sub pixel is represented as a percentage value with respect to 100%, where the Y value of the pixel P when white is displayed is 100%.

TABLE 2

| Sub pixel | R | G | B | C | Ye |
|---|---|---|---|---|---|
| Y value (%) | 12 | 23 | 4 | 27 | 34 |

As can be seen from Table 2, the Y value of the yellow sub pixel Ye is highest, and the Y value of the cyan sub pixel C is second highest. Namely, among the five primary colors displayed by the five types of sub pixels, yellow displayed by the yellow sub pixel Ye has the highest luminance (brightness), and cyan displayed by the cyan sub pixel C has the second highest luminance (brightness). As shown in FIG. 17, the yellow sub pixel Ye that displays yellow having the highest luminance and the cyan sub pixel C that displays cyan having the second highest luminance are not adjacent to each other.

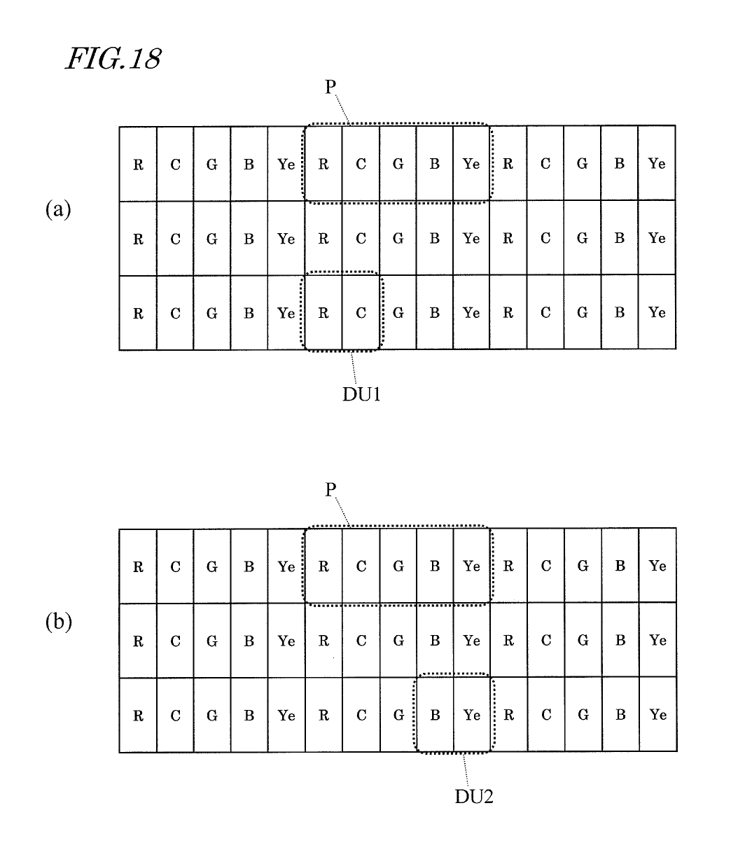

The five types of sub pixels include, as a plurality of display units that display white, a first display unit DU1 as shown in FIG. 18(a) formed of the red sub pixel R and the cyan sub pixel G, and a second display unit DU2 as shown in FIG. 18(b) formed of the blue sub pixel B and the yellow sub pixel Ye. The first display unit DU1 is formed of the red sub pixel R and the cyan sub pixel C for displaying red and cyan, which are complementary to each other, and thus can display white. The second display unit DU2 is formed of the blue sub pixel B and the yellow sub pixel Ye for displaying blue and yellow, which are complementary to each other, and thus also can display white.

As described above, the five types of sub pixels forming each pixel P include a plurality of display units, each of which can display a specific color. Therefore, for providing display in a reduced state, each of the plurality of display units can be used as a virtual pixel. As a result, the visual resolution can be improved.

In the liquid crystal display device 200 in this embodiment also, between in the case where the colors of two pixels continuous along the row direction of an input image are the specific color and black from left and in the case where the colors of such two pixels are black and the specific color from left, the luminances of the five types of sub pixels forming the pixel P corresponding to the two pixels of the input image are at least partially different. Namely, the output of the sub pixel unit is different between in the former case and in the latter case.

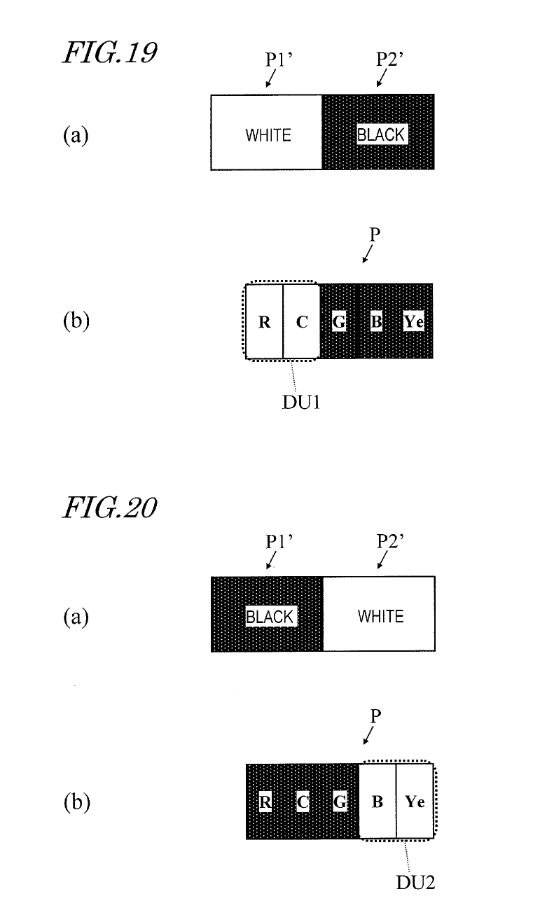

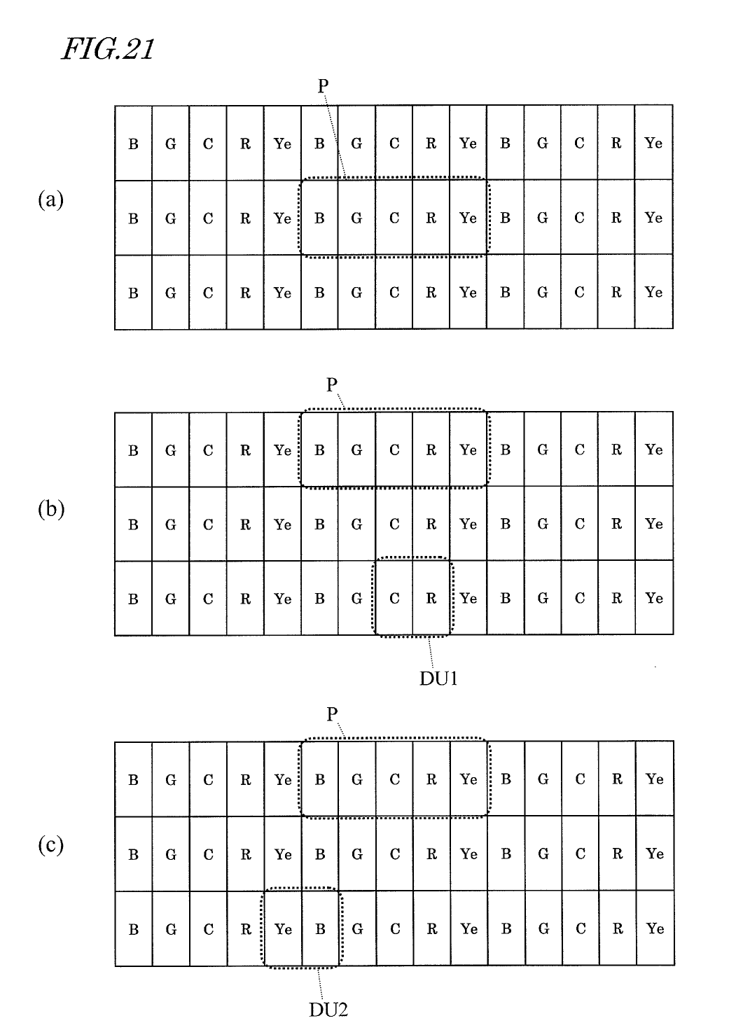

For example, in FIG. 19(a), the colors of two pixels P1′ and P2′ of an input image are white and black from left. In this case, as shown in FIG. 19(b), in the pixel P of the liquid crystal display device 200 corresponding to these two pixels, the red sub pixel R and the cyan sub pixel C (sub pixels forming the first display unit DU1) are lit up, whereas the green sub pixel G, the blue sub pixel B and the yellow sub pixel Ye are left unlit. By contrast, in FIG. 20(a), the colors of two pixels P1′ and P2′ of an input image are black and white from left. In this case, as shown in FIG. 20(b), in the pixel P of the liquid crystal display device 200 corresponding to these two pixels, the blue sub pixel B and the yellow sub pixel Ye (sub pixels forming the second display unit DU2) are lit up, whereas the red sub pixel R, the cyan sub pixel C and the green sub pixel G are left unlit.

As can be seen from a comparison between the case shown in FIGS. 19(a) and (b) and the case shown in FIGS. 20(a) and (b), in the former case, among the first sub pixel and the second sub pixel (the yellow sub pixel Ye and the cyan sub pixel C), the cyan sub pixel C, which is located relatively leftward in one pixel, has a higher luminance than that of the yellow sub pixel Ye, which is located relatively rightward in the pixel. By contrast, in the latter case, the yellow sub pixel Ye, which is located relatively rightward in one pixel, has a higher luminance than that of the cyan sub pixel C, which is located relatively leftward in the pixel.

In the pixel structure (sub pixel arrangement) shown in FIGS. 17 and 18, the plurality of display units for white are each formed of a plurality of sub pixels continuous in one pixel. However, the present invention is not limited to such a sub pixel arrangement.

FIG. 21(a) shows another example of sub pixel arrangement. In the example shown in FIG. 21(a), in each pixel P, the five types of sub pixels are located in the order of the blue sub pixel B, the green sub pixel G, the cyan sub pixel C, the red sub pixel R and the yellow sub pixel Ye from left to right. In this arrangement also, the yellow sub pixel Ye that displays yellow having the highest luminance and the cyan sub pixel C that displays cyan having the second highest luminance are not adjacent to each other.

The five types of sub pixels located as shown in FIG. 21(a) include, as a plurality of display units that display white, a first display unit DU1 as shown in FIG. 21(b) formed of the red sub pixel R and the cyan sub pixel C, and a second display unit DU2 as shown in FIG. 21(c) formed of the blue sub pixel B and the yellow sub pixel Ye. The display unit DU2 shown in FIG. 21(c) is formed of a plurality of sub pixels continuous over two pixels P. In this manner, among a plurality of display units for a specific color, one display unit may be located over two pixels P.

Even when the arrangement shown in FIG. 21 is adopted, the output of the sub pixel unit is different between in the case where the colors of two pixels continuous along the row direction of an input image are the specific color and black from left and in the case where the colors of such two pixels are black and the specific color from left.

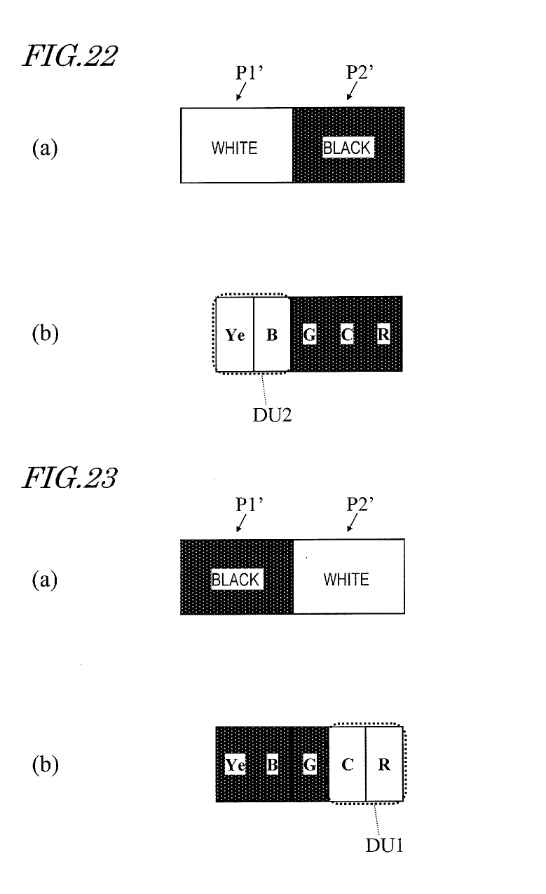

For example, in FIG. 22(a), the colors of two pixels P1′ and P2′ of an input image are white and black from left. In this case, as shown in FIG. 22(b), the blue sub pixel B and the yellow sub pixel Ye (sub pixels forming the second display unit DU2) are lit up, whereas the red sub pixel R, the green sub pixel G and the cyan sub pixel C are left unlit. By contrast, in FIG. 23(a), the colors of two pixels P1′ and P2′ of an input image are black and white from left. In this case, as shown in FIG. 23(b), the red sub pixel R and the cyan sub pixel C (sub pixels forming the first display unit DU1) are lit up, whereas the green sub pixel G, the blue sub pixel B and the yellow sub pixel Ye are left unlit.

As can be seen from a comparison between the case shown in FIGS. 22(a) and (b) and the case shown in FIGS. 23(a) and (b), in the former case, among the first sub pixel and the second sub pixel (the yellow sub pixel Ye and the cyan sub pixel C), the yellow sub pixel Ye, which is located relatively rightward in one pixel (see FIG. 21), has a higher luminance than that of the cyan sub pixel C, which is located relatively leftward in the pixel. By contrast, in the latter case, the cyan sub pixel C, which is located relatively leftward in one pixel, has a higher luminance than that of the yellow sub pixel Ye, which is located relatively rightward in the pixel.

A color for which a plurality of display units are not defined by the five types of sub pixels cannot be displayed by use of a virtual pixel. However, even in this case, a sub pixel that displays a color closest to such a color may be lit up while the sub pixel(s) in the vicinity of such a sub pixel is(are) lit up in a supplementary manner. Thus, a difference in the luminance distribution can be represented.

In this embodiment, the sub pixel X₁ and the sub pixel X₂, each of that displays a color different from any of red, green and blue are the cyan sub pixel C and the yellow sub pixel Ye. However, the present invention is not limited to this. For example, a magenta sub pixel that displays magenta may be used instead of one of the cyan sub pixel C and the yellow sub pixel Ye.

In Embodiments 1 and 2 described above, the number of primary colors used for display matches the number of sub pixels forming the pixel P. However, these numbers do not need to match each other. Namely, a plurality of sub pixels forming one pixel P may include a plurality of sub pixels that display the same color. For example, each pixel P may be formed of two red sub pixels R, the green sub pixel G, the blue sub pixel B, the yellow sub pixel Ye and the cyan sub pixel C. In this case, the number of types of sub pixels forming each pixel P is five but the number of sub pixels forming each pixel P is six.

(Resolution Conversion Device)

A specific structure of the resolution conversion device usable for a display device according to the present invention will be described using, as an example, the resolution conversion device 10 of the liquid crystal display device 100 shown in FIG. 1.

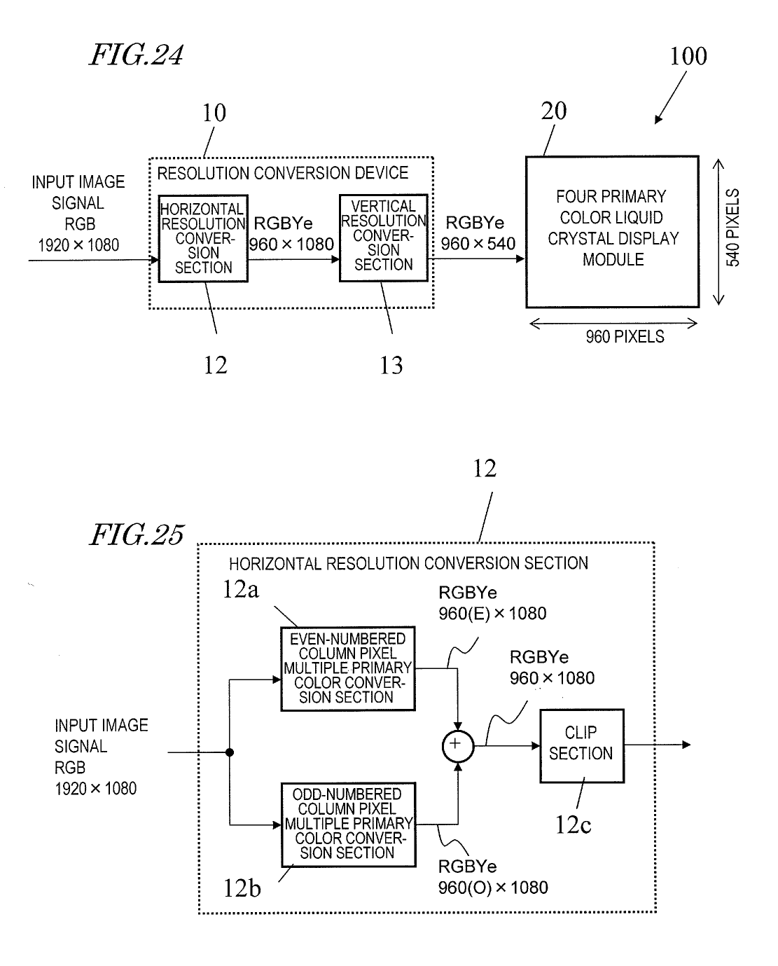

FIG. 24 shows an example of specific structure of the resolution conversion device 10. In the example shown in FIG. 24, an input image has 1920 pixels in a horizontal direction and 1080 pixels in a vertical direction. The resolution of the input image is a so-called Full-HD resolution. Such an input image is displayed by use of the four primary color liquid crystal display module 20. In this example, the liquid crystal display panel of the four primary color liquid crystal display module 20 has 960 pixels in the horizontal direction and 540 pixels in the vertical direction. The resolution is converted to ½ in both of the horizontal direction and the vertical direction.

The resolution conversion device 10 shown in FIG. 24 includes a horizontal resolution conversion section 12 and a vertical resolution conversion section 13. An image signal input from an external device is first input to the horizontal resolution conversion section 12 to have the number of pixels in the horizontal direction compressed to ½. Owing to this, the physical number of pixels in the horizontal direction becomes 960. However, in the liquid crystal display device 100 in a preferable embodiment of the present invention, each of two display units having an intermediate size between the size of the sub pixel and the size of the pixel can be used as a virtual pixel. Therefore, the input image can keep 1920 pixels, which is twice the physical number of pixels, as the visual resolution. In other words, in the horizontal direction, the input image can be displayed on the liquid crystal display panel having half of the number of pixels of the input image, without deteriorating the resolution.

The signal which is output from the horizontal resolution conversion section 12 is sent to the vertical resolution conversion section 13 to be processed in the vertical direction and thus has the number of pixels in the vertical direction compressed to ½. In this embodiment, the sub pixels are located in the horizontal direction in each pixel P, and therefore the resolution conversion in the vertical direction is performed by a conventional technique. The resolving power of the human eye is lower to the vertical direction than to the horizontal direction. Therefore, the sense regarding the resolution is not much influenced by such processing in the vertical direction.

The signal processed with resolution conversion in both of the horizontal direction and the vertical direction is input to the four primary color liquid crystal display module 20. The four primary color liquid crystal display module 20 includes the liquid crystal display panel, the gate driver, the source driver, the timing controller, the backlight device (illumination device) and the like. The input signal is output from the gate driver and the source driver which are controlled by the timing controller, and is displayed on the liquid crystal display panel as an image.

FIG. 25 shows an example of specific structure of the horizontal resolution conversion section 12. The horizontal resolution conversion section 12 shown in FIG. 25 includes an even-numbered column pixel multiple primary color conversion section 12a, an odd-numbered column pixel multiple primary color conversion section 12b and a clip section 12c.

The image signal input to the horizontal resolution conversion section 12 is first divided into a component corresponding to pixels of even-numbered columns and a component corresponding to pixels of odd-numbered columns. These components are respectively processed with different primary color conversions (conversions from three colors into four colors) by the even-numbered column pixel multiple primary color conversion section 12a and the odd-numbered column pixel multiple primary color conversion section 12b, and then are re-blended. At this point, the number of pixels in the horizontal direction becomes ½.

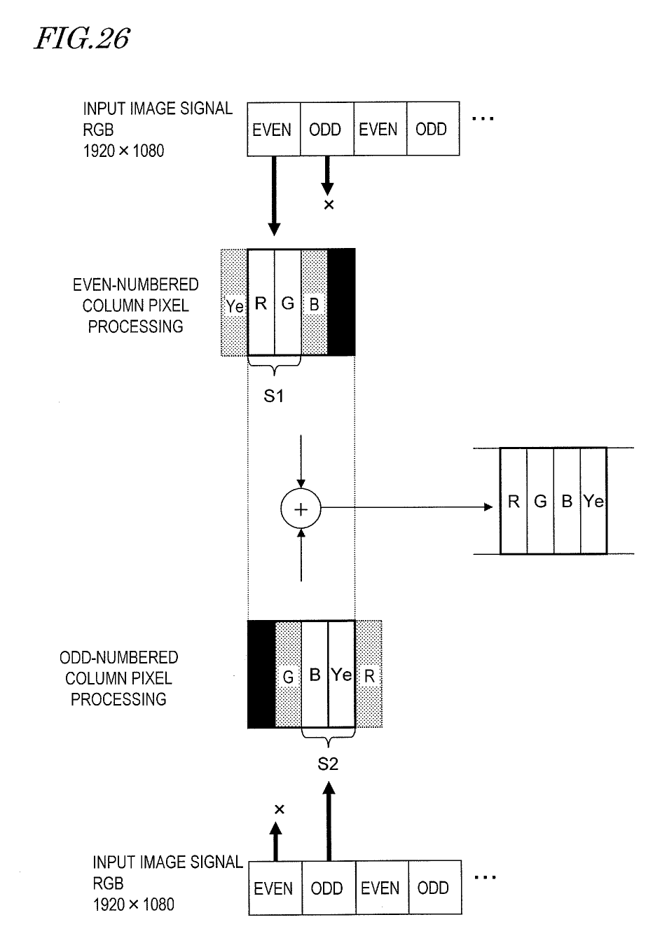

FIG. 26 schematically shows specific processing performed on the pixels of the even-numbered columns and the pixels of the odd-numbered columns of an input image. As shown in FIG. 26, the pixels of the even-numbered columns are subjected to signal processing so as to be each basically represented by a sub set S1 of the red sub pixel R and the green sub pixel G. At this point, the pixels may not be represented only by the sub set S1 depending on the color of the input image signal. In such a case, the yellow sub pixel Ye and the blue sub pixel B adjacent to the sub set S1 are used in a supplementary manner. At least a part of the sub set S1 and also the yellow sub pixel Ye and the blue sub pixel B used in a supplementary manner act as a “display unit” having an intermediate size as described above.

Similarly, the pixels of the odd-numbered columns are subjected to signal processing so as to be each represented by a sub set S2 of the blue sub pixel B and the yellow sub pixel Ye. At this point, the pixels may not be represented only by the sub set S2 depending on the color of the input image signal. In such a case, the green sub pixel G and the red sub pixel R adjacent to the sub set S2 are used in a supplementary manner. At least a part of the sub set S2 and also the green sub pixel G and the red sub pixel R used in a supplementary manner act as a display unit having an intermediate size as described above.

In this manner, two pixels (even-numbered column, odd-numbered column) of the original input image signal are assigned to one sub set. As a result of this processing, the three primary color signal of the input image is represented by the four types of sub pixels, for each pixel of the even-numbered columns and for each pixel of the odd-numbered columns. After this, additive blending is performed in units of sub pixels. Thus, four primary color image data reduced to ½ can be obtained. Depending on the amount lit up in a supplementary manner, an overflow may occur after the addition is performed in units of sub pixels. Therefore, in this example, clipping is performed by the clip section 12c (see FIG. 25) in a final stage as a measure against the overflow. Alternatively, normalization may be performed when the pixels of the input image are assigned to each sub set in order to prevent the overflow in advance.

As described above, in the horizontal resolution conversion section 12, the pixels of the even-numbered columns of the input image are each represented by the sub set S1, and the pixels of the odd-numbered columns of the input image are each represented by the sub set S2. Therefore, the input image can be represented with a resolution twice the display resolution. In the case of this example, the liquid crystal display panel having 960 pixels in the horizontal direction can represent the input image with a resolution corresponding to 1920 pixels.

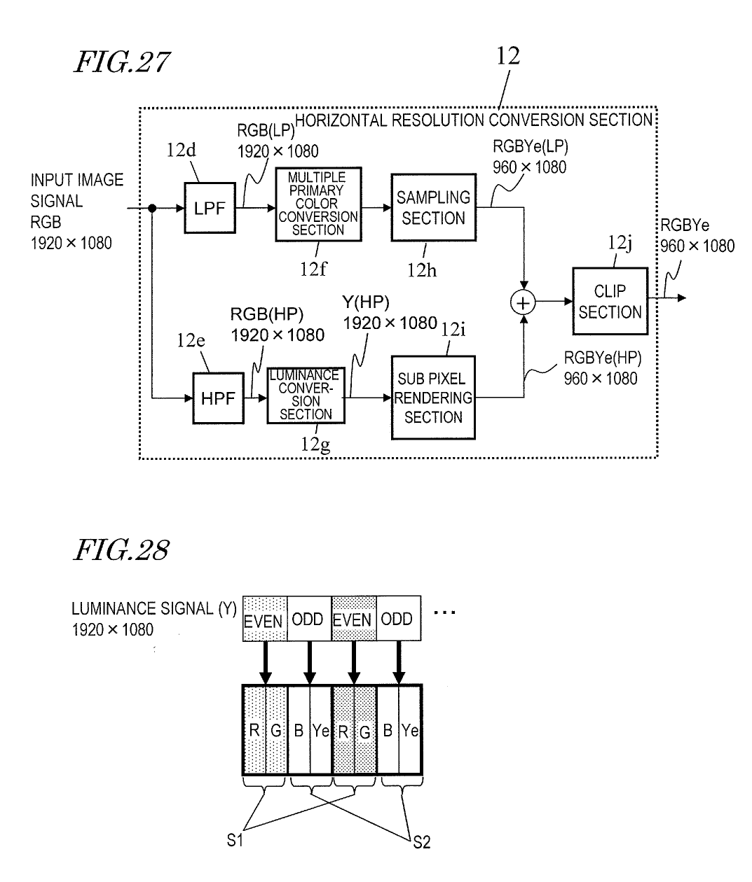

FIG. 27 shows another example of specific structure of the horizontal resolution conversion section 12. The horizontal resolution conversion section 12 shown in FIG. 27 includes a low pass filter (LPF) 12d, a high pass filter (HPF) 12e, a multiple primary color conversion section 12f, a luminance conversion section 12g, a sampling section 12h, a sub pixel rendering section 12i, and a clip section 12j.

In this example, an input image signal is processed after being divided into a low range signal and a high range signal by the LPF 12d and the HPF 12e. After passing the LPF 12d, the low range signal is processed with multiple primary color conversion (conversion from three colors into four colors) by the multiple primary color conversion section 12f and then is sampled with the resolution of the liquid crystal display panel by the sampling section 12h. The resultant signal does not include a high range component. Therefore, the resultant signal represents a deteriorated resolution but has color components accurately saved therein.

By contrast, after passing the HPF 12e, the high range signal is converted into a luminance signal Y by the luminance conversion section 12g. Then, as schematically shown in FIG. 28, pixels of even-numbered columns are each assigned to a sub set S1 and pixels of the odd-numbered columns are each assigned to a sub set S2 by the sub pixel rendering section 12i. The sub set S1 formed of the red sub pixel R and the green sub pixel G is controlled to be lit up so as to represent the high range component of each pixel of the even-numbered columns. Similarly, the sub set S2 formed of the blue sub pixel B and the yellow sub pixel Ye is controlled to be lit up so as to represent the high range component of each pixel of the odd-numbered columns. These signals have the high range components of the input image signal saved therein.

The sub set S1 is formed of the red sub pixel R and the green sub pixel G, and therefore is colored in addition to representing the luminance. The same is true with the sub set S2. However, the human visibility is declined in terms of color separation precision in a high range of spatial frequency. Therefore, the above-described problem can be avoided by designing the HPF 12e in an appropriate manner (the coloring is made unrecognizable by setting the cutoff frequency fc above the frequency of the limit of color separation) and controlling the sub pixel(s) adjacent to each of the sub sets S1 and S2 so as to be lit up in a supplementary manner.

In a final stage, the low range component signal which does not include the high range component but has the color components saved therein and the high range component signal assigned to the sub sets S1 and S2 are added together. Thus, an input signal which has both of the colors and the resolution saved therein can be displayed on the liquid crystal display panel having half of the number of pixels of the input image in the horizontal direction. The operation and the purpose of the clip section 12j are substantially the same as those of the example shown in FIG. 25.

### INDUSTRIAL APPLICABILITY

According to the present invention, a multiple primary color display device which suppresses the decline of display quality even when the resolution of an input image is higher than the resolution of the display device is provided. A multiple primary color display device according to the present invention can provide high quality display and therefore is usable for various types of electronic devices including liquid crystal TVs.

### REFERENCE SIGNS LIST

10, 11 Resolution conversion device
12 Horizontal resolution conversion section
13 Vertical resolution conversion section
20 Four primary color liquid crystal display module
21 Five primary color liquid crystal display module
100, 200 Liquid crystal display device
P Pixel
R Red sub pixel
G Green sub pixel
B Blue sub pixel
C Cyan sub pixel
Ye Yellow sub pixel
DU1 First display unit
DU2 Second display unit

1. A display device comprising a plurality of pixels arranged in a matrix including a plurality of rows and a plurality of columns, each of the plurality of pixels being formed of four or five types of sub pixels that display different colors from each other, wherein:
in each of the plurality of pixels, a first sub pixel that displays a color having the highest luminance among the colors displayed by the four or five types of sub pixels, and a second sub pixel that displays a color having the second highest luminance, are located so as not to be adjacent to each other;
the four or five types of sub pixels include a plurality of display units, each of which is capable of displaying a specific color and is formed of one sub pixel or two or more continuous sub pixels; and
when an input image has a resolution higher than a display resolution defined by a total number of the plurality of pixels, each of the plurality of display units is usable as a virtual pixel for providing display.

2. The display device of claim 1, wherein:
in each of the plurality of pixels, the four or five types of sub pixels are arranged in one row by a plurality of columns; and
when the resolution of the input image is higher than the display resolution, between in a first case where colors of two pixels continuous along a row direction of the input image are the specific color and black from left and in a second case where the colors of such two pixels are black and the specific color from left, luminances of the four or five types of sub pixels forming a pixel, among the plurality of pixels of the display device, corresponding to the two pixels of the input image are at least partially different.

3. The display device of claim 2, wherein:
each of the plurality of display units is formed of one sub pixel or two or more sub pixels continuous in one pixel;
in the first case, among the first sub pixel and the second sub pixel, one sub pixel located relatively leftward in one pixel has a higher luminance than that of the other sub pixel located relatively rightward in the pixel; and
in the second case, among the first sub pixel and the second sub pixel, one sub pixel located relatively rightward in one pixel has a higher luminance than that of the other sub pixel located relatively leftward in the pixel.

4. The display device of claim 2, wherein:
one display unit among the plurality of display units is formed of two or more sub pixels located over two pixels;
in the first case, among the first sub pixel and the second sub pixel, one sub pixel located relatively rightward in one pixel has a higher luminance than that of the other sub pixel located relatively leftward in the pixel; and
in the second case, among the first sub pixel and the second sub pixel, one sub pixel located relatively leftward in one pixel has a higher luminance than that of the other sub pixel located relatively rightward in the pixel.

5. The display device of claim 1, wherein each of the plurality of pixels is formed of four types of sub pixels that display different colors from each other.

6. The display device of claim 5, wherein the four types of sub pixels are a red sub pixel that displays red, a green sub pixel that displays green, a blue sub pixel that displays blue, and a yellow sub pixel that displays yellow.

7. The display device of claim 6, wherein:
the first sub pixel that displays the color having the highest luminance is the yellow sub pixel; and
the second sub pixel that displays the color having the second highest luminance is the green sub pixel.

8. The display device of claim 6, wherein when the specific color is white, the plurality of display units are a first display unit formed of the red sub pixel, the green sub pixel and the blue sub pixel, and a second display unit formed of the blue sub pixel and the yellow sub pixel.

9. The display device of claim 6, wherein:
when the specific color is yellow, the plurality of display units are a first display unit formed of the red sub pixel and the green sub pixel, and a second display unit formed of the yellow sub pixel.

10. The display device of claim 1, wherein each of the plurality of pixels is formed of five types of sub pixels that display different colors from each other.

11. The display device of claim 10, wherein the five types of sub pixels are a red sub pixel that displays red, a green sub pixel that displays green, a blue sub pixel that displays blue, a cyan sub pixel that displays cyan, and a yellow sub pixel that displays yellow.

12. The display device of claim 11, wherein:
the first sub pixel that displays the color having the highest luminance is the yellow sub pixel; and
the second sub pixel that displays the color having the second highest luminance is the cyan sub pixel.

13. The display device of claim 11, wherein when the specific color is white, the plurality of display units are a first display unit formed of the red sub pixel and the cyan sub pixel, and a second display unit formed of the blue sub pixel and the yellow sub pixel.
